(19) United States
(12) Patent Application Publication
(10) Pub. No.: US 2004/0126585 A1
(43) Pub. Date: Jul. 1, 2004

(54) Water dispersible commode/bedpan liner

(76) Inventors: John E. Kerins, Neenah, WI (US); Earle H. Sherrod, Appleton, WI (US); Corneleus J. Bosselaar, Appleton, WI (US); Ann L. McCormack, Cumming, GA (US)

Correspondence Address: Jonathan P Taylor PhD, Brinks, Hofer, Gilson, & Lione, P O Box 10395, Chicago, IL, 60610, US

(21) Appl. No.: 10/331,145

(22) Filed: Dec. 27, 2002

(51) Int. Cl. B32B 5/18

(52) U.S. Cl. 428/411.1

(57) ABSTRACT

A water dispersible commode/bedpan liner. The liner is a film useful as a flushable commode or bedpan liner. The liner may be positioned before use and then placed in a toilet afterwards where it is flushed. The film is a two layer co-extruded film. At least half of the film is a predominately water soluble polymer. No more than half of the film is a skin fluid barrier layer of an extrudable polymer that may be biodegradable. The film also includes a chemical that is activated by tap water to help cause the film to break apart.

### BACKGROUND OF THE INVENTION

Disposable products have dramatically altered modern lifestyle, adding great convenience to everyday living for society. Such products generally are relatively inexpensive, sanitary and quick and easy to use. Disposal of such products, however, increasingly is a problem as landfills close and incineration contributes to urban smog and pollution. Consequently, there is a need for disposable products that may be disposed of without dumping or incineration. An ideal disposal alternative would be the use of municipal sewage treatment and private residential septic systems. Products suited for disposal in sewage systems that may be flushed down a conventional toilet are termed “flushable.” An essential feature of flushable products is that they must have sufficient strength for their intended use, yet lose structural integrity upon contact with water.

Numerous attempts have been made to produce flushable materials that retain their integrity and strength for their intended purpose yet may be disposed of via flushing in conventional toilets. One approach to producing a flushable product is to limit the size of the product so that it will readily pass through plumbing without causing obstructions or blockages. Such products often have high wet strength and do not disintegrate during flushing. Examples of this type of product include wipes such as baby wipes. This approach to flushability suffers the disadvantage, however, of being restricted to small sized articles. Many current flushable products are limited to such small articles.

Numerous consumer products, which were formerly unable to be disposed of in a conventional toilet, are made flushable today. Such products include water-soluble films, wipes, tampon applicators, etc. However, many consumer products have remained unflushable.

One such product that has remained unflushable to date is commode or bedpan liners. Individuals who are unable to use conventional water-flushing toilets due to urge incontinence, lack of mobility, or physical size frequently use bedpans, commodes, or toilet training chairs. In addition, campers, backpackers, or individuals without access to conventional running water supplies frequently use portable toileting devices. There are numerous toileting devices manufactured for use in such applications, however, cleaning the waste receptacle of such devices is a laborious and undesirable task, and exposes the individual to health risks. Additionally, transporting the bedpan or waste receptacle to a water-flushing toilet or other suitable disposal facility in order to dump the bodily wastes creates a potential for sloshing, splashing, or spilling of bodily wastes during transport and disposal. Such contamination on floors, bedding, or individuals creates health risks and is of a special concern to nurses or any caregiver that must perform this task numerous times.

In addition to preventing spills of bodily wastes or other materials within the container during transport, there is also a need for a convenient way to dispose of the container and material within the container. Disposal of used commode liners into a garbage may or other suitable disposal facility creates the risk of spreading infectious diseases, leads to undesirable odors, and increases the chances for spilling the commode liner's bodily-wastes during further handling.

For commode liners it is desired to contain and/or temporarily prevent passage of aqueous waste or other aqueous materials, and at some later time dispose of the barrier material in a clean and environmentally friendly manner. To be effective, the material of the commode liner should temporarily provide a barrier to leakage, and at the appropriate time desirably break up into components that facilitate suitable disposal, especially by flushing down a toilet, while minimizing adverse effects on the environment.

Conventional bedpan or commode liners comprise a water dissolvable/dispersible inner layer and an outer skin of a biodegradable polymer. While these films may eventually dissolve in a toilet, they take a great deal of time to do so and give the consumer the belief that the bedpan or commode liner is not flushable.

Prior containers using water sensitive layers of, for example, polyvinyl alcohol (PVOH) exist. Difficulties have been identified with these prior containers because many water sensitive materials like PVOH become dimensionally unstable when exposed to conditions of moderate to high humidity and tend to weaken or stretch. In use, for example, the material may stretch out of shape and/or weaken to the point of rupture. Attempts to add stability by increasing the barrier film thickness, for example, add unacceptable cost and/or increase the issues to be addressed upon disposal. Commode liners made of thicker films have a greater tendency to remain intact on flushing, for example, and clog toilets or downstream systems.

The need continues, therefore, for commode liners providing temporary barrier, latently dispersible properties that are stable under use conditions but also easily disposable under aqueous conditions as by flushing, for example. There is also a need to design the shape of the commode liner to maximize its flushability, especially when disposed of in a modern low water usage toilet. The present invention addresses this and similar needs.

Accordingly, what is needed in the art are commode/bedpan liners providing temporary barrier, latently dispersible properties that are stable under use conditions but also easily disposable under aqueous conditions as by flushing, for example. There is also a need to design the shape of the commode liner to maximize its flushability, especially when disposed of in a modern low water usage toilet.

### SUMMARY OF THE INVENTION

The present invention is directed to a flushable bedpan or commode liner comprising a water dissolvable/dispersible inner layer and an outer skin of an extrudable polymer. Additionally, the bedpan or commode liner includes a chemical mechanism that, when wetted, such as in a toilet, causes the bedpan or commode liner to rapidly break apart. The chemical mechanism may be a water-triggered material, a pH-triggered material, a superabsorbent material, a foam material, or any other material that, upon contact with tap water located in a toilet, will become wetted, thereby causing the bedpan or commode liner to break apart. The bedpan or commode liner of the present invention offers the performance of a conventional bedpan or commode liner with the additional option of disposal in a toilet.

The present invention is also directed to a method of forming a flushable bedpan or commode liner. The method comprises co-extruding a water dissolvable/dispersible polymer and an extrudable polymer. The water dissolvable/dispersible polymer, the extrudable polymer, or both may include the chemical mechanism that has been admixed with the water dissolvable/dispersible polymer, the extrudable polymer, or both prior to extrusion.

In one embodiment, the present invention describes a flushable bedpan or commode liner comprising a water dissolvable/dispersible polymer layer, an extrudable polymer layer, and a chemical mechanism. The liner comprises from about 50 to about 99.5% by weight of the water dissolvable/dispersible polymer and from about 0.5 to about 50% by weight of the extrudable polymer and the chemical mechanism is capable of causing the liner to break apart upon exposure to water.

The present invention provides a mechanism for eliminating disposal problems associated with various consumer products. A non-limiting detailed description of the invention and examples of specific embodiments are provided below.

Definitions

As used herein unless the context requires a different meaning, the following terms have the meanings set forth below:

As used herein and in the claims, the term “comprising” is inclusive or open-ended and does not exclude additional unrecited elements, compositional components, or method steps.

As used herein, the term “water dispersible” refers to structures which when placed in an aqueous environment will, with sufficient time, break apart into smaller pieces. As a result, the structure once dispersed may be more advantageously processable in recycling processes or flushable in, for example, septic and municipal sewage treatment systems. If desired, such structures may be made more water dispersible or the dispersion may be hastened by the use of agitation and/or certain triggering means. The actual amount of time will depend at least in part upon the particular end-use design criteria.

As used herein, the term “commode liner” refers to a liner for the waste receptacle of a toileting device such as a bed pan, toilet training chair, potty chair, portable toilet, commode, toilet, bucket, pail, or other suitable structure for toileting use by an individual. The commode liner is used to contain bodily wastes, and prevent contact of the bodily wastes with interior surfaces of the waste receptacle.

As used herein, the term “biodegradable” means that a material degrades from the action of naturally occurring microorganisms such as bacteria, fungi and algae.

As used herein, the term “water sensitive” means a structure or layer that loses integrity in contact with water as by means of breaking up or dissolving, for example, but which maintains effective strength for the desired application.

As used herein, the term “water soluble” means dissolves into water as a homogeneous solution.

As used herein, the term “inextensible” means having machine direction stretch of less than 15% measured using the TAPPI Test Method 494 OM-88 “Tensile Breaking Properties of Paper and Paperboard” as the test is described in U.S. Pat. No. 5,607,551, incorporated herein by reference in its entirety. The following parameters may be used: crosshead speed: 10.0 in/min (254 mm/min), full scale load: 10 lb (4,540 g.), jaw span (the distance between the jaws, sometimes referred to as the gauge length): 2.0 inches (50.8 mm), specimen width: 3 inches (76.2 mm). The testing device may be a Sintech, Model CITS-2000 (Systems Integration Technology Inc. Stoughton, Mass.—a division of MTS Systems Corporation, Research Triangle Park, N.C.).

As used herein “joined” includes configurations where one element is directly or indirectly attached to another element by any means including, but not limited to, adhesives, thermal bonding, sonic bonding, chemical bonding, mechanical bonding, pressure bonding, heat and pressure bonding, hydrogen bonding, fasteners, stitching, or other means known to those skilled in the art. Joined also includes elements indirectly joined together. By “indirectly joined” it is meant one element is attached to a second element by one or more intermediate members. For instance, the outer layers in an ordinary plywood laminate are indirectly joined to each other by the laminate's intermediate layers.

### DETAILED DESCRIPTION OF THE INVENTION

The present invention is directed to a flushable bedpan or commode liner comprising a water dissolvable/dispersible inner layer and an outer skin of an extrudable polymer. Additionally, the bedpan or commode liner includes a chemical mechanism that, when wetted, such as in a toilet, causes the bedpan or commode liner to rapidly break apart. The bedpan or commode liner of the present invention functions like conventional bedpan or commode liners currently used. However, unlike conventional bedpan or commode liners, the present invention is “flushable.” As used herein, the term “flushable” describes a product which rapidly loses integrity and strength when discarded in a conventional sink or toilet. The flushable feature of the bedpan or commode liner of the present invention comes from the chemical mechanism. When immersed in water, the chemical mechanism readily wets and causes the bedpan or commode liner to break apart and readily disperse under the flushing force of the toilet.

Water dissolvable/dispersible polymers useful in the present invention include any water dissolvable/dispersible polymer capable of being co-extruded into the bedpan or commode liner of the present invention. As used herein, the phrase “water dissolvable/dispersible polymer” describes polymers that lose integrity over time when in the presence of water and includes, but is not limited to, water-dissolvable polymers and water-dispersible polymers. Suitable polymers include, but are not limited to, polyvinyl alcohol (PVOH), PVOH/ethylene vinyl acetate (EVA) blends; polyalkylene oxides, such as polyethylene oxide (PEO) and ethylene oxide/propylene oxide copolymers, polymethacrylic acid, polymethacrylic acid copolymers, poly(2-ethyl oxazoline), polyvinyl methyl ether, polyvinyl pyrrolidone/vinyl acetate copolymers, methyl cellulose, ethyl cellulose, hydroxypropyl cellulose, hydroxypropyl methyl cellulose, ethyl hydroxyethyl cellulose, methyl ether starch, poly (n-isopropyl acrylamide), poly N-vinyl caprolactam, polyvinyl methyl oxazolidone, poly (2-isopropyl-2-oxazoline), poly (2,4-dimethyl-6-triazinyl ethylene); and blends and mixtures thereof.

The extrudable polymer is, in one embodiment, comprised from a majority of biodegradable polymers. The biodegradable polymers may be selected from a variety of biodegradable polymers, organic and inorganic and may include, but are not limited to, aliphatic polyesters; polylactides (PLA); polyhydroxybutyrate-co-valerates (PHB-PHV); polycaprolactones (PCL); sulfonated polyethylene terephthalates; blends and mixtures thereof. In one embodiment, the present invention uses an aliphatic polyester polymer including, but not limited to, poly(lactic acid), polybutylene succinate and polybutylene succinate-co-adipate. In yet another embodiment, the present invention uses poly(lactic acid) as the extrudable polymer.

The water dissolvable/dispersible polymer layer of the present invention may be made entirely of water dissolvable/dispersible polymer or may contain water-insoluble materials so long as the film disperses in water, such as in a conventional sink or toilet. Additionally, water dissolvable/dispersible polymer layers may also be made by combining various different types of water dissolvable/dispersible polymers. In some embodiments, it may be desirable to employ one or more additives into the water dissolvable/dispersible polymer layer including, but not limited to, compatibilizers, processing aids, plasticizers, tackifiers, detackifiers, slip agents, and anti-microbial agents, as fabricating agents or as modifiers depending on the specific properties desired in the film and the final product.

The chemical mechanism may be any mechanism that aids in causing the bedpan or commode liner to break apart when dispersed in toilet water. Examples of mechanisms useful in the present invention include, but are not limited to, a water-triggered material, a ph-triggered material, a superabsorbent material, a water-swellable clay or a foam material.

In one embodiment, the chemical mechanism is a superabsorbent material. As used herein, the term “superabsorbent material” (SAM) refers to a water-swellable, water-insoluble organic or inorganic material capable, under the most favorable conditions, of absorbing more than 15 times its weight in an aqueous solution containing 0.9 weight percent sodium chloride. Organic materials suitable for use as a superabsorbent material of the present invention may include natural materials such as agar, pectin, guar gum, and the like; as well as synthetic materials, such as synthetic hydrogel polymers. Such hydrogel polymers include, but are not limited to, alkali metal salts of polyacrylic acids, polyacrylamides, polyvinyl alcohol, ethylene maleic anhydride copolymers, polyvinyl ethers, hydroxypropylcellulose, polyvinylmorpholinone; and polymers and copolymers of vinyl sulfonic acid, polyacrylates, polyacrylamides, polyvinylpyrridine, and the like. Other suitable polymers include hydrolyzed acrylonitrile grafted starch, acrylic acid grafted starch, and isobutylene maleic anhydride copolymers and mixtures thereof. The hydrogel polymers are desirably lightly crosslinked to render the material substantially water insoluble. Crosslinking may, for example, be by irradiation or by covalent, ionic, van der Waals, or hydrogen bonding. The superabsorbent materials may be in any form suitable for use in absorbent composites including particles, fibers, flakes, spheres, and the like.

The superabsorbent material works in the present invention by absorbing water and swelling, thereby causing partial and/or total separation of the water dissolvable/dispersible polymer layer and the extrudable polymer layer such that these layers physically break apart.

In another embodiment, a foam material may be used that acts similar to a SAM by expanding upon exposure to water, thereby causing the liner to break apart. The foam material may be a compressed open-cell foam which expands on exposure to water. An example of such material would be a compressed re-expandable hydrophilic foam, such as a compressed cellulose or a composite cellulose-binder structure. On compression, the walls of the foam structure are moved to new locations, and the structure is held in its compressed shape by bonding interactions between the displaced walls. When fluid enters the system, these interactions are released, and the foam expands as the walls return from their displaced position. A second example of a foam material which expands on exposure to water is a swellable foam, such as a polyacrylate foam or a swellable polyurethane foam. In this case, the walls of the foam itself swell on exposure to water, leading to an expansion of the volume of the foam material.

In another embodiment, an inorganic swelling agent, such as a clay, may be used that acts similar to a SAM by expanding upon exposure to water. A specific example is bentonite clay from the montmorillonite group. This group includes a lamellar or sandwich structure of alumina and silica networks. Water hydrates the cation in the interlaminar space between platelets, causing the clay to swell. (The swelling is dependent on pH and the type of ion at the exchange site.)

Similarly, another embodiment of the chemical mechanism used to produce a flushable bedpan or commode liner includes using a chemical mechanism comprising a pH sensitive gelled polymer and storing the product in the presence of a separate acid pH solution. When the polymer film is placed in a large quantity of neutral pH water, it disintegrates as a result of the pH shift. Examples of pH sensitive polymers include, but are not limited to, polymers with acid functionality that are insoluble in the acid form and soluble when the acid is ionized. The pKa of the acid functionality determines the pH at which the film breaks up. Phthalic acid esters, such as those used for enteric coatings, are one class of such pH sensitive polymers, with poly(vinylacetate phthalate), cellulose acetate phthalate, and hydroxypropyl methylcellulose phthalate as specific examples. Methylmethacrylate-methacrylic acid copolmyers, acrylic acid resins and acid-functionalized polylactic acid provide further examples of pH sensitive polymers.

Another embodiment of the chemical mechanism used to produce a flushable bedpan or commode liner is to use polyvinyl alcohol polymers, or copolymers wherein one polymer is polyvinyl alcohol, which gel in the presence of borate ions in aqueous solution, but which break down in the presence of large excesses of water as the borate ion diffuses away from the polymer and the borate ion concentration decreases.

Still another embodiment of the chemical mechanism used to produce a flushable bedpan or commode liner is to use a salt-sensitive binder. For example, some acrylic copolymers precipitate in the presence of high concentrations of calcium ions.

Yet another embodiment of the chemical mechanism used to produce a flushable bedpan or commode liner is to use an ion-trigger polymer provides the required barrier to body fluids, yet weakens and disperses in plain toilet water. In the presence of aqueous salt solution, such as urine, the polymer is relatively inert. Water from the salt solution may reach the substrate only by a slow process of diffusion through the coating. The same polymer rapidly swells and weakens in plain water. The process of water penetration in the coating differs with the ion content of the solution.

Polymers that exhibit a lower critical solution temperature (LCST) or cloud point close to 25° C. in water are potentially suitable materials for the ion-trigger layer. Higher cloud point polymers are also suitable if their cloud point may be lowered by the addition of salt(s) or by copolymerization with another component to form a polymeric composition having the desired LCST.

Examples of polymers and their copolymers that exhibit such a behavior include, but are not limited to, polymethacrylic acid; polyvinyl pyrrolidone; polyvinyl methyl ether; polyvinyl alcohol; polyethylene oxide; hydroxy propyl cellulose; hydroxypropyl methyl cellulose; methyl cellulose; ethyl hydroxyethyl cellulose; isopropyl cellulose; methyl ether starch; poly(n-isopropyl acrylamide); poly(N-vinyl caprolactam); polyethyl oxazoline; poly(2-isopropyl-2-oxazoline); polyvinyl methyl oxazolidone; polyvinyl methyl oxazolidimone; poly(2,4-dimethyl-6-triazinylethylene); and ethylene oxide-propylene oxide copolymers. Examples of suitable polymers are described in U.S. Pat. No. 5,509,913 to Richard S. Yeo, incorporated herein by reference; and in U.S. Ser. No. 08/775,223, by Pavneet Singh Mumick and Yihua Chang, filed Dec. 31, 1996, and assigned to the Kimberly-Clark Corporation, incorporated herein by reference.

The desired LCST may be achieved by employing copolymerization technology to produce copolymers that exhibit the proper phase transition temperature. Copolymerization permits the selection and commingling of advantageous properties of various polymers. For example, copolymerization is used to control water solubility and wet strength of the ion-trigger layer. Further, copolymers are produced that have improved thermoplastic properties, which facilitate melt processing. Such copolymers comprise, for example, a first comonomer that is thermoreversibly insoluble in water, and a second comonomer that is water insoluble irrespective of temperature. Examples of the first comonomers include, but are not limited to polymethacrylic acid, polyvinyl alcohol, polyvinyl pyrrolidone, polyethyl oxazoline, polyethylene oxide, and polyvinyl methyl ether. Examples of the second comonomer include, but are not limited to ethylene, propylene, butylene, alkyl acrylate, alkyl methacrylate, acrylic ester, methacrylic ester, vinyl acetate, styrene, and the like.

Furthermore, copolymers of ethylene oxide and propylene oxide or butylene oxide are also suitable, as are copolymers of N-n-butyl acrylamide and N-t-butyl acrylamide with acrylamide and N-isopropyl acrylamide.

The bedpan or commode liner includes, in one embodiment, from about 50 to about 99.5% by weight of the water dissolvable/dispersible polymer and from about 0.5 to about 50% by weight of the extrudable polymer. In another embodiment, bedpan or commode liner includes, in one embodiment, from about 60 to about 95% by weight of the water dissolvable/dispersible polymer and from about 5 to about 40% by weight of the extrudable polymer. In yet another embodiment, bedpan or commode liner includes, in one embodiment, from about 70 to about 90% by weight of the water dissolvable/dispersible polymer and from about 10 to about 30% by weight of the extrudable polymer. These weight percentages are based upon the weight of the film and do not include the weight of the chemical mechanism.

According to another aspect of this invention, the bedpan or commode liner of the present invention is prepared by any process wherein two layers of polymer are formed into a film. In one embodiment a method for making a bilayer polymer film is provided. This method includes coextruding a water dissolvable/dispersible polymer and an extrudable polymer to form a laminate comprising a water dissolvable/dispersible polymer layer including the water dissolvable/dispersible polymer and a second layer including the extrudable polymer.

The chemical mechanism may be added at different points in the process, depending on the chemical mechanism used. In many embodiments, such as with a foam, a SAM or some chemicals, the water dissolvable/dispersible polymer, the extrudable polymer, or both may include the chemical mechanism that has been admixed with the water dissolvable/dispersible polymer, the extrudable polymer, or both prior to extrusion. In other embodiments, the chemical mechanism may comprise a chemical that is sprayed on or coated onto the water dissolvable/dispersible polymer layer, the extrudable polymer layer, or both.

Those skilled in the art will recognize that the present invention is capable of many modifications and variations without departing from the scope thereof. Accordingly, the detailed description set forth above is meant to be illustrative only and is not intended to limit, in any manner, the scope of the invention as set forth in the appended claims.

What is claimed is:

1. A flushable bedpan or commode liner comprising:
a water dissolvable/dispersible polymer layer;
an extrudable polymer layer; and
a chemical mechanism;
wherein the liner comprises from about 50 to about 99.5% by weight of the water dissolvable/dispersible polymer and from about 0.5 to about 50% by weight of the extrudable polymer;
further wherein the chemical mechanism is capable of causing the liner to break apart upon exposure to water.

2. The flushable bedpan or commode liner of claim 1, wherein the liner comprises from about 60 to about 95% by weight of the water dissolvable/dispersible polymer and from about 5 to about 40% by weight of the extrudable polymer.

3. The flushable bedpan or commode liner of claim 2, wherein the liner comprises from about 70 to about 90% by weight of the water dissolvable/dispersible polymer and from about 10 to about 30% by weight of the extrudable polymer.

4. The flushable bedpan or commode liner of claim 1, wherein the chemical mechanism comprises a superabsorbent material.

5. The flushable bedpan or commode liner of claim 4, wherein the superabsorbent material is selected from agar, pectin, guar gum, alkali metal salts of polyacrylic acids, polyacrylamides, polyvinyl alcohol, ethylene maleic anhydride copolymers, polyvinyl ethers, hydroxypropylcellulose, polyvinylmorpholinone; polymers of vinyl sulfonic acid, copolymers of vinyl sulfonic acid, polyacrylates, polyacrylamides, polyvinylpyrridine, hydrolyzed acrylonitrile grafted starch, acrylic acid grafted starch, isobutylene maleic anhydride copolymers and mixtures thereof.

6. The flushable bedpan or commode liner of claim 1, wherein the chemical mechanism comprises a foam.

7. The flushable bedpan or commode liner of claim 6, wherein the foam is selected from a compressed open-cell foam and a swellable foam.

8. The flushable bedpan or commode liner of claim 7, wherein the foam is a compressed open-cell foam selected from a compressed cellulose foam and a composite cellulose-binder structure.

9. The flushable bedpan or commode liner of claim 7, wherein the foam is a swellable foam selected from a polyacrylate foam and a swellable polyurethane foam.

10. The flushable bedpan or commode liner of claim 1, wherein the chemical mechanism comprises a pH sensitive polymer.

11. The flushable bedpan or commode liner of claim 10, wherein the pH sensitive polymer is selected from phthalic acid esters, methylmethacrylate-methacrylic acid copolmyers, acrylic acid resins and acid-functionalized polylactic acid.

12. The flushable bedpan or commode liner of claim 11, wherein the pH sensitive polymer is a phthalic acid ester selected from poly(vinylacetate phthalate), cellulose acetate phthalate, and hydroxypropyl methylcellulose phthalate.

13. The flushable bedpan or commode liner of claim 1, wherein the chemical mechanism comprises an ion-trigger polymer.

14. The flushable bedpan or commode liner of claim 13, wherein the ion-trigger polymer is selected from polymethacrylic acid; polyvinyl pyrrolidone; polyvinyl methyl ether; polyvinyl alcohol; polyethylene oxide; hydroxy propyl cellulose; hydroxypropyl methyl cellulose; methyl cellulose; ethyl hydroxyethyl cellulose; isopropyl cellulose; methyl ether starch; poly(n-isopropyl acrylamide); poly(N-vinyl caprolactam); polyethyl oxazoline; poly(2-isopropyl-2-oxazoline); polyvinyl methyl oxazolidone; polyvinyl methyl oxazolidimone; poly(2,4-dimethyl-6-triazinylethylene); and ethylene oxide-propylene oxide copolymers.

15. The flushable bedpan or commode liner of claim 1, wherein the chemical mechanism comprises a water-swellable clay.

16. The flushable bedpan or commode liner of claim 15, wherein the water-swellable clay is bentonite clay.

17. A flushable bedpan or commode liner comprising:
a water dissolvable/dispersible polymer layer;
an extrudable polymer layer; and
a chemical mechanism selected from a water-triggered material, a pH-triggered material, a superabsorbent material, a water-swellable clay and a foam material;
wherein the liner comprises from about 50 to about 99.5% by weight of the water dissolvable/dispersible polymer and from about 0.5 to about 50% by weight of the extrudable polymer;
further wherein the chemical mechanism is capable of causing the liner to break apart upon exposure to water.

18. The flushable bedpan or commode liner of claim 17, wherein the liner comprises from about 60 to about 95% by weight of the water dissolvable/dispersible polymer and from about 5 to about 40% by weight of the extrudable polymer.

19. The flushable bedpan or commode liner of claim 18, wherein the liner comprises from about 70 to about 90% by weight of the water dissolvable/dispersible polymer and from about 10 to about 30% by weight of the extrudable polymer.

20. The flushable bedpan or commode liner of claim 17, wherein the chemical mechanism comprises a superabsorbent material and the superabsorbent material is selected from agar, pectin, guar gum, alkali metal salts of polyacrylic acids, polyacrylamides, polyvinyl alcohol, ethylene maleic anhydride copolymers, polyvinyl ethers, hydroxypropylcellulose, polyvinylmorpholinone; polymers of vinyl sulfonic acid, copolymers of vinyl sulfonic acid, polyacrylates, polyacrylamides, polyvinylpyrridine, hydrolyzed acrylonitrile grafted starch, acrylic acid grafted starch, isobutylene maleic anhydride copolymers and mixtures thereof.

21. The flushable bedpan or commode liner of claim 17, wherein the chemical mechanism comprises a foam and the foam is selected from a compressed open-cell foam and a swellable foam.

22. The flushable bedpan or commode liner of claim 21, wherein the foam is a compressed open-cell foam selected from a compressed cellulose foam and a composite cellulose-binder structure.

23. The flushable bedpan or commode liner of claim 21, wherein the foam is a swellable foam selected from a polyacrylate foam and a swellable polyurethane foam.

24. The flushable bedpan or commode liner of claim 17, wherein the chemical mechanism comprises a pH sensitive polymer and the pH sensitive polymer is selected from phthalic acid esters, methylmethacrylate-methacrylic acid copolmyers, acrylic acid resins and acid-functionalized polylactic acid.

25. The flushable bedpan or commode liner of claim 24, wherein the pH sensitive polymer is a phthalic acid ester selected from poly(vinylacetate phthalate), cellulose acetate phthalate, and hydroxypropyl methylcellulose phthalate.

26. The flushable bedpan or commode liner of claim 17, wherein the chemical mechanism comprises an ion-trigger and the ion-trigger polymer is selected from polymethacrylic acid; polyvinyl pyrrolidone; polyvinyl methyl ether; polyvinyl alcohol; polyethylene oxide; hydroxy propyl cellulose; hydroxypropyl methyl cellulose; methyl cellulose; ethyl hydroxyethyl cellulose; isopropyl cellulose; methyl ether starch; poly(n-isopropyl acrylamide); poly(N-vinyl caprolactam); polyethyl oxazoline; poly(2-isopropyl-2-oxazoline); polyvinyl methyl oxazolidone; polyvinyl methyl oxazolidimone; poly(2,4-dimethyl-6-triazinylethylene); and ethylene oxide-propylene oxide copolymers.

27. The flushable bedpan or commode liner of claim 17, wherein the chemical mechanism comprises a water-swellable clay and the water-swellable clay is bentonite clay.
